(19) United States
(12) Patent Application Publication
(10) Pub. No.: US 2002/0159044 A1
(43) Pub. Date: Oct. 31, 2002

(54) High resolution maskless lithography field lens for telecentric system

(75) Inventors: Wenhui Mei, Plano, TX (US); Takashi Kanatake, Dallas, TX (US)

Correspondence Address: HAYNES AND BOONE, LLP, 901 MAIN STREET, SUITE 3100, DALLAS, TX, 75202, US

(73) Assignee: Ball Semiconductor, Inc., Allen, TX

(21) Appl. No.: 10/063,240

(22) Filed: Apr. 2, 2002

Related U.S. Application Data
(60) Provisional application No. 60/287,666, filed on Apr. 30, 2001.

(51) Int. Cl. G03B 27/42

(52) U.S. Cl. 355/67; 355/53; 359/855; 359/642; 359/224; 430/296

(57) ABSTRACT

A system for performing digital lithography onto a subject is provided. The system includes a telecentric lens system that utilizes a field lens for redirecting light without distortion. The field lens may be utilized with a microlens array, a grating, and other lenses to achieve a desired result. A Fresnel lens may be used in place of the field lens and may be combined with the microlens array into a diffraction optical element.

### CROSS REFERENCE TO RELATED APPLICATIONS

This application claims the benefit of U.S. Provisional Application No. 60/287,666, filed on Apr. 30, 2001.

### BACKGROUND

The present invention relates generally to display systems such as a photolithography system, and more particularly, to a system and method for utilizing a field lens for redirecting light.

In conventional analog photolithography systems, the photographic equipment requires a mask for printing an image onto a subject. The subject may include, for example, a photo resist coated semiconductor substrate for manufacture of integrated circuits, metal substrate for etched lead frame manufacture, conductive plate for printed circuit board manufacture, or the like. A patterned mask or photomask may include, for example, a plurality of lines or structures.

U.S. Pat. Ser. No. 09/480,796, filed Jan. 10, 2000 discloses a digital photolithography system. The system provides a series of patterns to a pixel panel, such as a deformable mirror device or a liquid crystal display. The pixel panel provides images consisting of a plurality of pixel elements, corresponding to the provided pattern, that may be projected onto the subject. Each of the plurality of pixel elements is simultaneously focused to different sites of the subject. After the image has been exposed, the subject and pixel elements move and the next image is exposed. As a result, light can be projected onto or through the pixel panel to expose the plurality of pixel elements on the subject, and the pixel elements can be moved and altered, according to the pixel mask pattern, to create contiguous images on the subject.

The light projected by the pixel panel generally passes through one or more lenses before exposing the plurality of pixel elements on the subject. The lens(es) may be operable to reduce the image size projected by the pixel panel so that it will be the correct size on the subject, focus the image on the subject, or perform similar conventional optical transformations. However, the quality and scale of the image must be carefully monitored to ensure that the image is of the correct size and that no distortion has occurred to the image being projected onto the subject.

Therefore, certain improvements are desired for digital photolithography systems. For one, it is desirable to redirect the projected light for a specific exposure without distortion. It is also desirable to maintain the scale of an image, to provide high light energy efficiency, to provide high productivity and resolution, and to be more flexible and reliable.

### SUMMARY

A technical advance is provided by a novel method and system for performing digital lithography onto a subject. In one embodiment, the system comprises a point array for generating a digital pattern. The point array has a plurality of array elements that are operable to direct a plurality of lights representing the digital pattern towards a telecentric lens system. The system also includes the telecentric lens system, which is operable to receive the plurality of lights from the point array and direct the digital pattern towards the subject. The lens system includes a first lens operable to perform transformations on the received light and to direct the received light towards a second lens. The second lens receives light from the first lens and redirects the light towards the subject without distortion.

In another embodiment, an optical diffraction element comprises a translucent substrate and a plurality of translucent concentric circles formed on the substrate. Each concentric circle comprises a first edge comprising a plurality of steps that ascend relative to the substrate at a first angle and a second edge that ascends relative to the substrate at a second angle that is greater than the first angle. Each concentric circle also comprises a plateau portion forming an upper side of the circle relative to the substrate and connecting the first and second edges.

### BRIEF DESCRIPTION OF DRAWINGS

FIG. 1 is a diagrammatic view of an improved digital photolithography system for implementing various embodiments of the present invention.

FIG. 2 is a diagrammatic view illustrating a portion of the digital photolithography system of FIG. 1 utilizing a telecentric lens system formed in part by a field lens.

FIG. 3 illustrates the telecentric lens system of FIG. 2 with the addition of a microlens array.

FIG. 4 is an enlarged view of two of the microlenses in the portion of FIG. 3 within the circle.

FIG. 5 is a diagrammatic view of the telecentric lens system of FIG. 3 with two of each component.

FIG. 6 is an enlarged view of the intersection of the two microlens arrays and the two field lenses in the portion of FIG. 5 within the circle.

FIG. 7 illustrates the lens system enlargement of FIG. 6 utilizing coherent light.

FIG. 8 is a diagrammatic view of another embodiment of a portion of the telecentric lens system of FIG. 6 using a diffraction optical element as a substitute for the microlens array and the field lens.

FIG. 9 is a diagrammatic illustration of the telecentric lens system of FIG. 5 with the field lenses reversed and located in front of the microlens arrays.

FIG. 10 is an enlarged view of the intersection of the two microlens arrays and the two field lenses in the portion of FIG. 9 within the circle.

FIG. 11 illustrates the lens system enlargement of FIG. 10 utilizing coherent light.

FIG. 12 is a diagrammatic view of the telecentric lens system of FIG. 3 utilizing multiple lenses and a grating positioned between the microlens array and a subject.

FIG. 13 illustrates the lens system of FIG. 12 utilizing coherent light.

FIG. 14 illustrates the lens system of FIG. 13 with the field lenses positioned between the microlens array and the grating.

FIGS. 15-17 illustrate a Fresnel lens and microlens array combined into a diffraction optical element.

### DETAILED DESCRIPTION

The present disclosure relates to display and exposure systems, such as can be used in semiconductor photolithographic processing. It is understood, however, that the following disclosure provides many different embodiments, or examples, for implementing different features of the invention. Specific examples of components and arrangements are described below to simplify the present disclosure. These are, of course, merely examples and are not intended to be limiting.

In the following description, the same numerals and/or letters may be used. It is noted that this repetition does not in itself indicate a relationship between the various embodiments and/or configurations discussed.

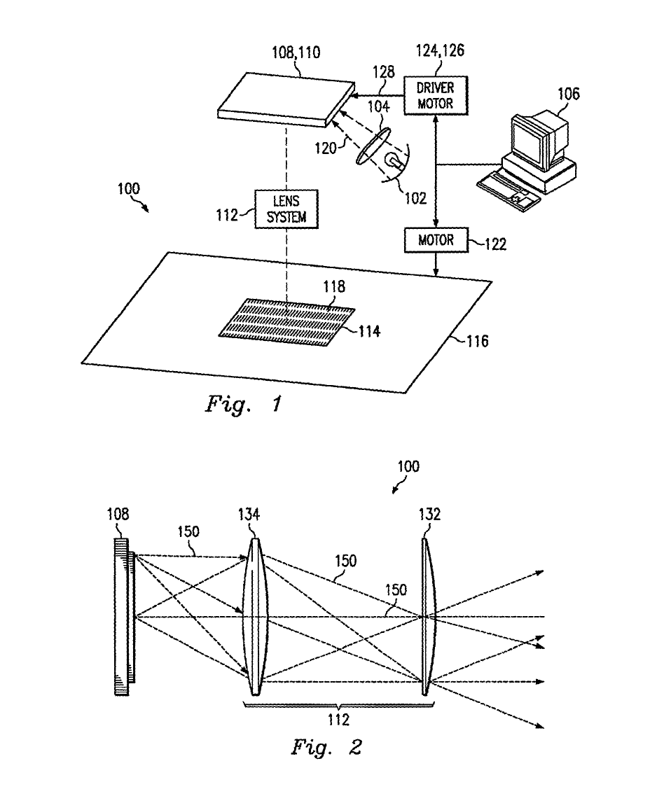

Referring now to FIG. 1, a maskless photolithography system 100 is one example of a system that can benefit from the present invention. In the present example, the maskless photolithography system 100 includes a light source 102, a first lens system 104, a computer aided pattern design system 106, a pixel panel 108, a panel alignment stage 110, a second lens system 112, a subject 114, and a subject stage 116. A resist layer or coating 118 may be disposed on the subject 114. The light source 102 may be an incoherent light source (e.g., a Mercury lamp) that provides a collimated beam of light 120 which is projected through the first lens system 104 and onto the pixel panel 108. Alternatively, the light 102 source may be an array comprising, for example, laser diodes or light emitting diodes (LEDs) that are individually controllable to project light.

The pixel panel 108 is provided with digital data via suitable signal line(s) 128 from the computer aided pattern design system 106 to create a desired pixel pattern (the pixel-mask pattern). The pixel-mask pattern may be available and resident at the pixel panel 108 for a desired, specific duration. Light emanating from (or through) the pixel-mask pattern of the pixel panel 108 then passes through the second lens system 112 and onto the subject 114. In this manner, the pixel-mask pattern is projected onto the resist coating 118 of the subject 114.

The computer aided mask design system 106 can be used for the creation of the digital data for the pixel-mask pattern. The computer aided pattern design system 106 may include computer aided design (CAD) software similar to that which is currently used for the creation of mask data for use in the manufacture of a conventional printed mask. Any modifications and/or changes required in the pixel-mask pattern can be made using the computer aided pattern design system 106. Therefore, any given pixel-mask pattern can be changed, as needed, almost instantly with the use of an appropriate instruction from the computer aided pattern design system 106. The computer aided mask design system 106 can also be used for adjusting a scale of the image or for correcting image distortion.

In some embodiments, the computer aided mask design system 106 is connected to a first motor 122 for moving the stage 116, and a driver 124 for providing digital data to the pixel panel 108. In some embodiments, an additional motor 126 may be included for moving the pixel panel. The system 106 can thereby control the data provided to the pixel panel 108 in conjunction with the relative movement between the pixel panel 108 and the subject 114.

As is discussed below in greater detail, the second lens system 112 may include one or more point arrays, field lenses, projection lenses, gratings, and/or other components to achieve a desired result.

Telecentric Lens System

Referring now to FIG. 2, in one embodiment, the photolithography system 100 of FIG. 1 (not shown in its entirety) may incorporate telecentricity into the second lens system 112, which in the present embodiment includes a projection lens 134 and a field lens 132. A standard lens system has a central perspective, which causes objects that are graduated in depth to be magnified differently (i.e., an object closer to the lens will be magnified more than an object farther from the lens). A telecentric lens system provides an image that is free from perspective distortion and so magnification is independent of object distance. Therefore, the scale of the object remains constant within the telecentric range of the system.

In operation, the pixel panel 108, which in the current embodiment is a programmable digital mirror device (DMD), reflects the light 120 of FIG. 1 (not shown) as light 150. The reflected light 150 may be coherent or incoherent. The light 150 is directed by the DMD 108 through the projection lens 134. It is noted that the lens 134 may serve to magnify or reduce an image embodied by the light 150, focus the light on an image plane, and/or perform a variety of optical transformations on the light 150. The lens 134 is operable to direct the light 150 towards the field lens 132. The field lens 132 redirects the light 150 without distorting or otherwise affecting the quality of an image embodied by the light 150.

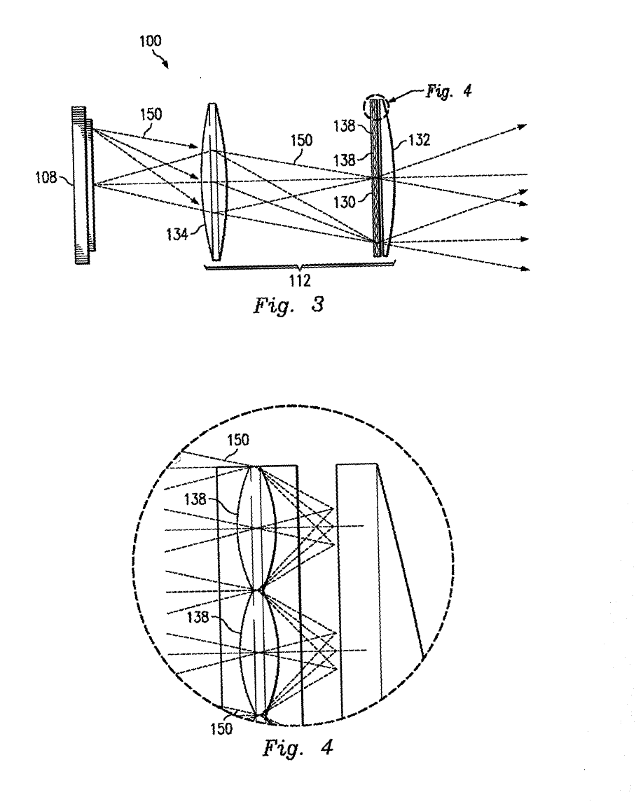

Referring now to FIG. 3, in yet another embodiment, the telecentric lens system 112 of FIG. 2 is illustrated with a point array 130. In the present embodiment, the point array 130 is a compilation of individual microlenses 138 or a microlens array. The microlens array 130 may have as many individual microlenses 138 as there are pixel elements in the pixel panel 108. For example, if the pixel panel 108 is a DMD with 600×800 pixels, then the microlens array 130 may have 600×800 microlenses. For example, the number of lenses may be different from the number of pixel elements in the pixel panel 108. In these embodiments, a single microlens 138 may accommodate multiple pixels elements of the DMD or the pixel elements can be modified to account for alignment.

In operation, light 150 is projected by the DMD 108, through the lens 134, and into the microlens array 130. The microlens array 130 is operable to focus the light 150 onto a plurality of points on the field lens 132. As described previously, the field lens 132 serves to redirect the light 150 in such a way that the image embodied by the light 150 is not distorted or otherwise effected.

Referring now to FIG. 4, two microlenses 138 of the microlens array 130 of FIG. 3 are illustrated in greater detail. The light 150 is projected into the microlenses 138. In the present embodiment, the microlenses 138 are operable to focus the light which enters each microlens 138 onto an image plane (not shown). Each microlens 138 may focus the light which enters that microlens 138 onto a single point, so that there is a unique focal point for each microlens 138. Alternatively, the microlenses 138 may be operable to focus the light onto a single, shared point, so that a plurality of microlenses 138 are directing the light 150 to a common focal point.

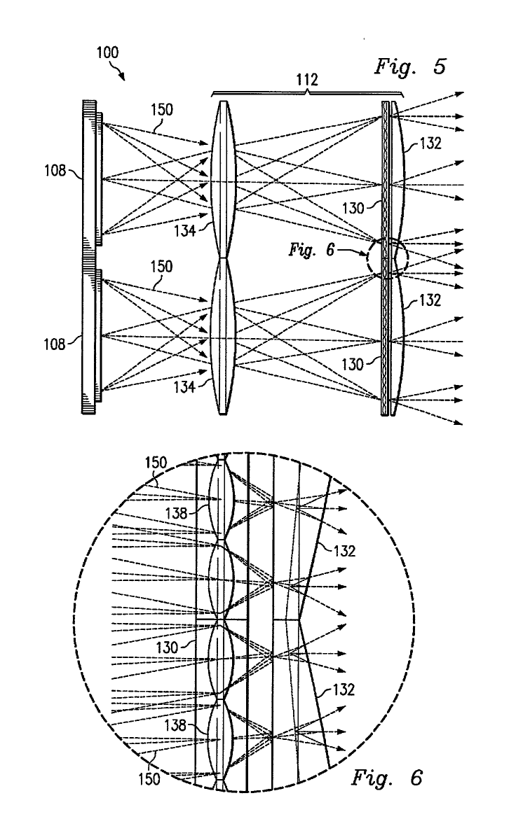

Referring now to FIG. 5, in yet another embodiment, the telecentric lens system 112 of FIG. 3 is illustrated with two pixel panels 108, two lenses 134, two microlens arrays 130, and two field lenses 132. One or more gratings 140 may be present. In the present embodiment, the light 150 is non-coherent. In operation, the telecentric lens system 112 may be used in a manner similar that described in relation to FIG. 3.

Referring now to FIG. 6, four lenses 138 of the microlens array 130 of FIG. 5 and a portion of each field lens 132 are illustrated in greater detail. Light 150 enters each microlens 138 and is focused on an image plan which, in the present embodiment, is on the adjacent surface of the field lens 132. The field lenses 132 may then redirect the light 150 without distorting the image embodied by the light.

Referring now to FIG. 7, the portion of the telecentric lens system 112 as illustrated in FIG. 6 is shown where coherent light is projected onto the microlenses 138, rather than the incoherent light illustrated in FIG. 6.

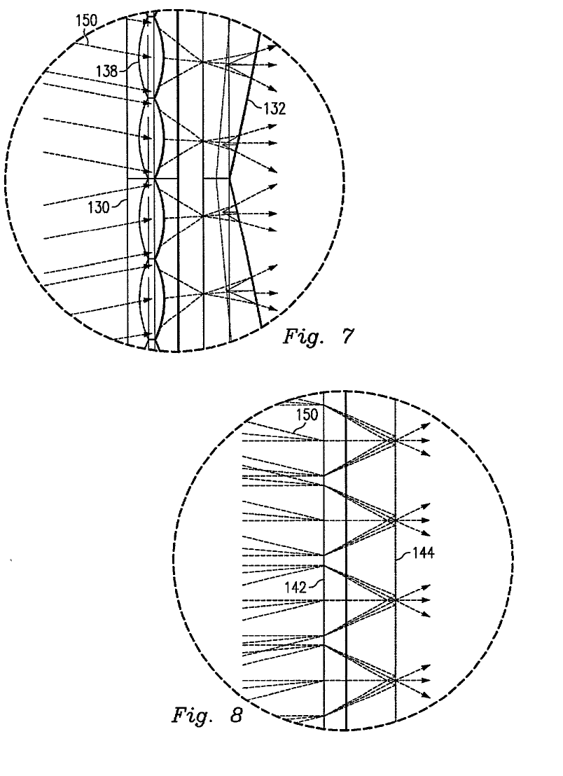

Referring now to FIG. 8, in still another embodiment, a diffraction optical element 142 may be substituted for the microlens arrays 130 and the field lenses 132 of FIGS. 5 and 6. The light 150 enters the optical element 142 in a similar manner to the light entering the microlenses 138 of FIG. 6. The optical element 142 focuses the light 150 on an image plane 144 in a manner similar to the way in which the microlenses 138 of FIG. 6 focus the light 150 on the surface of the field lenses 132. It is noted that the optical element 142 may be constructed in a number of ways so as to incorporate various combinations of microlens arrays 130, field lenses 132, and/or other optical components.

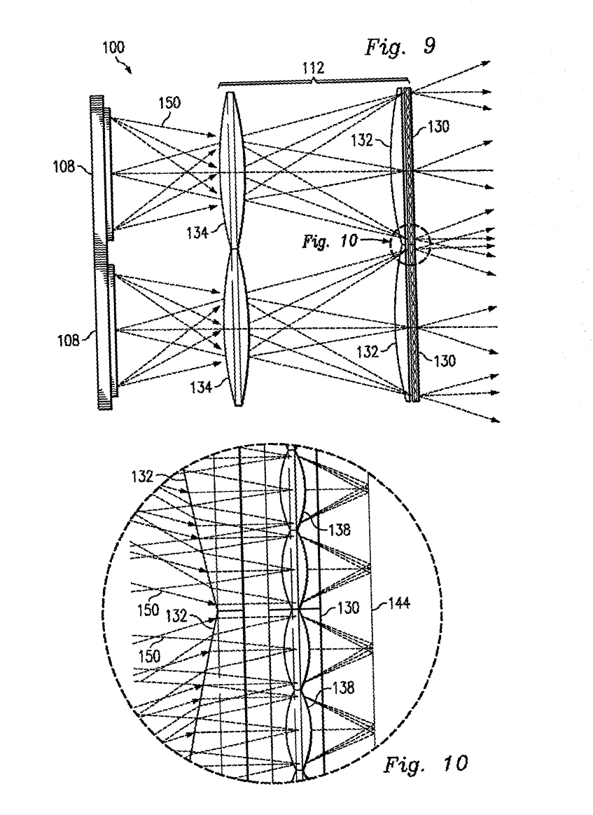

Referring now to FIG. 9, in another embodiment, the two field lenses 132 in the telecentric lens system 112 of FIG. 5 have been reversed and placed between the lenses 134 and the microlens arrays 130. Therefore, the light 150 is being projected from the field lenses 132 onto the adjacent microlens arrays 130, rather than from the microlens arrays 130 onto the field lenses 132 as illustrated in FIG. 5. In the present embodiment, the light 150 is non-coherent.

Referring now to FIG. 10, four lenses 138 of the microlens array 130 of FIG. 9 and a portion of each field lens 132 are illustrated in greater detail. The field lenses 132 redirect the light 150 onto the microlenses 138. The microlenses 138 may then focus the light onto an image plane 144. The image plane 144 may be the subject 114, another optical component, or any other image plane desired. In addition, the microlenses 138 may be designed so as to focus light on a plurality of focal points corresponding to the plurality of microlenses 138, or the microlenses 138 may be designed so as to focus the light on a smaller number of focal points, where one or more of the microlenses 138 are focused on the same point.

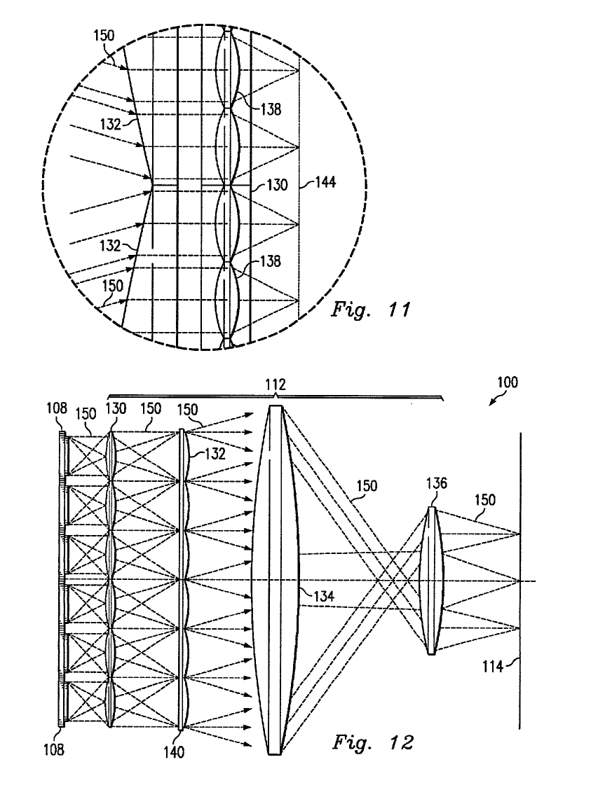

Referring now to FIG. 11, the portion of the telecentric lens system 112 as illustrated in FIG. 10 is shown where coherent light is projected onto the field lenses 132, rather than the incoherent light of FIG. 10.

Referring now to FIG. 12, in yet another embodiment, a second projection lens 136, a grating 140, a plurality of field lenses 132, and a plurality of DMDs 108 have been added to the second lens system 112 as illustrated in FIG. 3. The grating 140 may be a conventional shadow mask device that is used to eliminate and/or reduce certain bandwidths of light and/or diffractions between individual pixels of the pixel panel 108. The grating 140 may take on various forms, and in some embodiments, may be replaced with another device or not used at all.

In operation, light 150 is reflected from the pixel panels 108 and through a microlens array 130, as previously described. The light 150 then passes through the grating 140 before reaching the field lenses 132. The field lenses 132 redirect the light 150 to the lens 134. The lens 134, which in the present embodiment is relatively large compared to the field lenses 132, focuses the light 150 onto the lens 136. The lens 136 may be a high-resolution lens capable of projecting the light 150 onto the subject 114. In the present embodiment, the lenses 134, 136 serve as an optical reduction system that reduces an image embodied by the light 150. For example, the lenses 134, 136 may reduce an image which enters the lens 134 and is projected from the lens 136 at a five to one ratio. Therefore, the image that is projected onto the subject 114 will be five times smaller than the image that is projected from the field lenses 132 onto the lens 134. Other reduction ratios may be accomplished in a similar manner, as may magnification and/or other optical transformations. In the present embodiment, the light 150 is non-coherent.

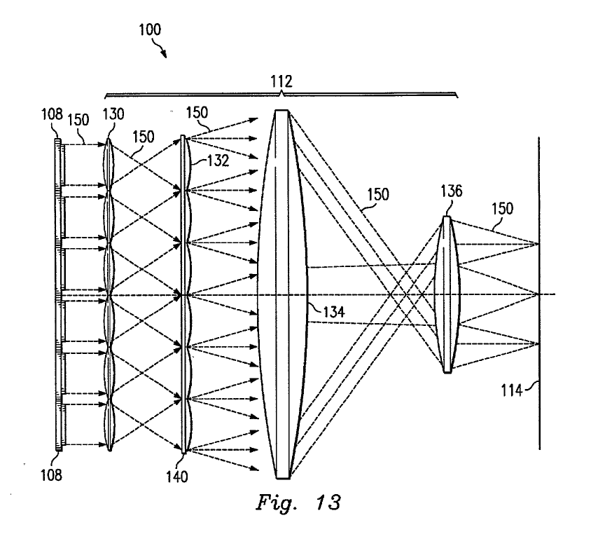

Referring now to FIG. 13, the telecentric lens system 112 of FIG. 12 is illustrated where coherent light is reflected by the DMDs 108, rather than the incoherent light of FIG. 12.

Referring now to FIG. 14, in another embodiment, the telecentric lens system of FIG. 12, using coherent light, is illustrated with the field lenses 132 positioned between the microlens array 130 and the grating 140. The microlens array 130 projects the light 150 onto the field lenses 132, rather than the grating 140 as is illustrated in FIG. 12. The light 150 passes through the field lens 132 and onto the grating 140. The grating 140 passes the light to the lenses 134, 136. As described in relation to FIG. 12, the lenses may operate to reduce the image at a predefined ratio. The image is then projected onto the subject 114. In the present embodiment, there is a corresponding field lens 132 for each microlens 138 of the microlens array 130. It is noted that this one-to-one correspondence may be altered to accomplish other desired results.

Fresnel lens

Referring now to FIGS. 15-17, in still another embodiment, a Fresnal lens 152, such as is commonly known in the field of optics, may be utilized with a microlens array 130 and substituted for the field lens 132 of the preceding figures as follows. This substitution retains many of the benefits afforded by the field lens 132 of the preceding figures. It is noted that combining a Fresnal lens with other lenses may be desirable to achieve particular results. In operation, light is projected onto the Fresnal lens 152. The light passes through the Fresnal lens 152 before continuing to the microlens array 130.

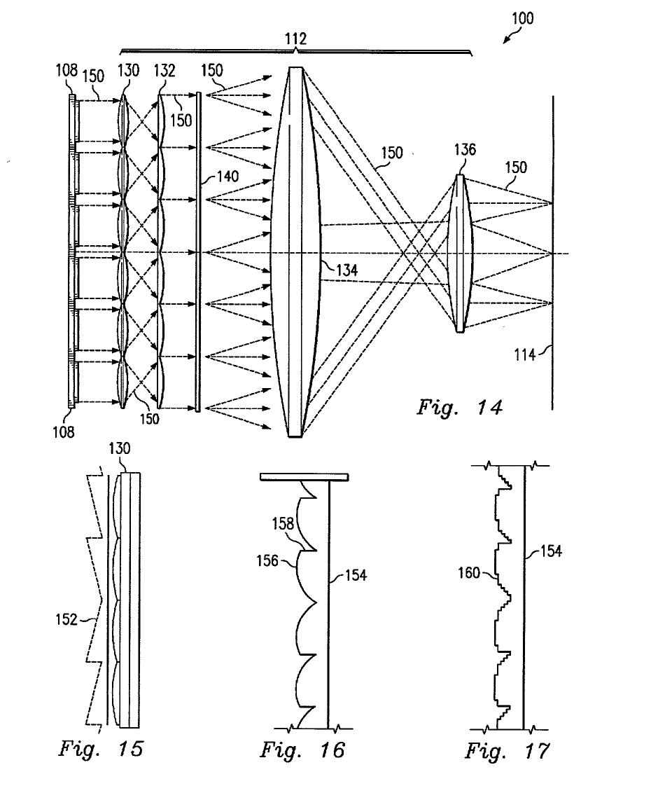

Referring now to FIG. 16, the Fresnel lens 152 and the microlens array 130 of FIG. 18 may be combined into a diffraction optical element 154, such as the element 142 of FIG. 8. In the present example, the diffraction optical element 154 includes a series of curves 156, with each curve having a relatively straight outside (relative to the center of the diffraction optical element 154) edge 158. The straight edge 158 marks the outside edge of each concentric circle of the Fresnel lens 152. In the present embodiment, each concentric circle forming the Fresnel lens 152 is combined with multiple microlenses 138 from the microlens array 130. Therefore, in the optical element 154, each concentric circle of the Fresnel lens 152 includes a concentric circle of microlenses 138. In other embodiments, the density and placement of the microlenses 138 in the concentric circles of the Fresnel lens 152 may vary depending on the desired properties of the optical element 154.

Referring now to FIG. 17, the optical element 154 is illustrated comprising a series of steps 160, rather than the curves 156 illustrated in FIG. 16. In the present embodiment, each curve 156 of the optical element 154 of FIG. 16 comprises an identical number of steps 160, although varying numbers of steps for each curve 156 may be desirable. The number and location of the steps 160 may vary to reflect a desired result. For example, increasing the number of steps 160 approximating a single curve 156 of FIG. 16 while reducing the size of each step 160 may result in a closer approximation of the curve 156. This “stepped” combination presents advantages in ease of manufacture, while offering functionality that is similar to the curved combination of FIG. 16.

While the invention has been particularly shown and described with reference to the preferred embodiment thereof, it will be understood by those skilled in the art that various changes in form and detail may be made therein without departing from the spirit and scope of the invention. For example, it is within the scope of the present invention that alternate types and/or arrangements of microlenses, pixel panels and/or lenses may be used. Furthermore, the order of components such as the field lens 132, the microlens array 130, the lenses 134 and 136, and/or the grating 140 may be altered in ways apparent to those skilled in the art. Additionally, the type and number of components may be supplemented, reduced or otherwise altered. For example, in another embodiment, the microlens array 130 and the field lens 132 may be replaced by a single component such as a diffraction optical element 154. In still another embodiment, the pixel panel may be replaced entirely by laser diodes or light emitting diodes (LEDs) that are individually controllable to project light. Therefore, the claims should be interpreted in a broad manner, consistent with the present invention.

1. A system for performing digital lithography on a subject, the system comprising:
a point array for generating a digital pattern, the point array having a plurality of array elements operable to direct a plurality of lights representing the digital pattern towards a telecentric lens system; and
the telecentric lens system, the lens system operable to receive the plurality of lights from the point array and direct the digital pattern towards the subject, the lens system including:
a first lens operable to direct the received light towards a second lens, the first lens operable to perform transformations on the received light; and
a second lens for receiving light from the first lens and redirecting the light towards the subject without distortion.

2. The system of claim 1 further including a microlens array positioned between the first and second lenses.

3. The system of claim 2 wherein the second lens is a field lens.

4. The system of claim 2 wherein the second lens is a Fresnel lens.

5. The system of claim 4 wherein the Fresnel lens and the microlens array are combined to form a diffraction optical element.

6. The system of claim 1 wherein the point array is a pixel panel.

7. The system of claim 1 wherein the point array is a diode array.

8. The system of claim 1 further including a diffraction optical element positioned between the point array and the telecentric lens system, the diffraction optical element operable to direct the plurality of lights representing the digital pattern towards the telecentric lens system.

9. The system of claim 1 further including a third and fourth lens positioned between the telecentric lens system and the subject, wherein the third and fourth lenses are operable to alter a projected size of the digital pattern on the subject.

10. A system for performing digital lithography on a subject, the system comprising:
a point array for generating a digital pattern, the point array having a plurality of array elements operable to direct a plurality of lights representing the digital pattern towards a telecentric lens system; and
the telecentric lens system, the lens system operable to receive the plurality of lights from the point array and direct the digital pattern towards the subject, the lens system including:
an image lens operable to receive the plurality of lights from the point array and to perform transformations on the received light;
a microlens array operable to receive the plurality of lights from the image lens and to focus the lights; and
a field lens operable to receive the focused plurality of lights from the microlens array and to direct the light towards the subject without perspective distortion.

11. A method for performing digital lithography on a subject using a telecentric lens system, the method comprising:
directing a plurality of individual light elements representing a digital pattern towards the telecentric lens system;
altering a property of the digital pattern using a first lens of the telecentric lens system; and
redirecting the digital pattern without distortion towards the subject using a second lens of the telecentric lens system, so that the digital pattern is projected onto the subject without perspective distortion.

12. The method of claim 11 further including:
projecting light from a light source towards a pixel panel, wherein the pixel panel comprises a plurality of array elements; and
generating the digital pattern using the pixel panel by altering specific array elements to reflect or not reflect the projected light.

13. The method of claim 12 further including focusing the plurality of individual light elements using a microlens array, wherein at least one array element of the point array corresponds to at least one microlens of the microlens array.

14. The method of claim 11 further including projecting the plurality of individual light elements using a diode array.

15. An optical diffraction element comprising:
a translucent substrate; and
a plurality of translucent concentric circles formed on the substrate, wherein each concentric circle comprises:
a first edge comprising a plurality of steps, wherein the steps ascend relative to the substrate at a first angle;
a second edge, wherein the second edge ascends relative to the substrate at a second angle that is greater than the first angle; and
a plateau portion forming an upper side of the circle relative to the substrate and connecting the first and second edges.

16. The element of claim 15 wherein the second edge comprises a plurality of ascending steps.

17. The optical diffraction element of claim 15 wherein a plurality of center points provide centers for a plurality of sets of concentric circles.

18. The optical diffraction element of claim 15 wherein each step includes an approximately square corner.

19. The optical diffraction element of claim 15 wherein each circle further comprises at least a first and second layer, and wherein the first layer includes a plurality of microlenses and the second layer includes a Fresnal lens, so that the first and second layers produce the first and second edges and the plateau portion when combined.

20. A method for making an optical diffraction element, the method comprising:
forming a translucent base;
applying a first concentric circle onto the base; and
applying at least a second concentric circle onto the first concentric circle, wherein a width of the second concentric circle is less than a width of the first concentric circle, so that a stepped slope is formed up at least one side of the optical diffraction element.

21. The method of claim 20 further including merging the first and second concentric circles to form the optical diffraction element, wherein one of the first and second concentric circles comprises a plurality of microlenses and the other of the first and second concentric circles comprises a Fresnal lens.
